(19) United States
(12) Patent Application Publication
(10) Pub. No.: US 2021/0381565 A1
(43) Pub. Date: Dec. 9, 2021

(54) SYSTEM AND METHOD FOR APPLYING BRAKES TO A STEEL WHEELED VEHICLE

(71) Applicant: EL-TRAC HOLDING LLC, Canton, OH (US)

(72) Inventor: Christopher Glenn Norris, Sherrodsville, OH (US)

(73) Assignee: EL-TRAC HOLDING LLC, Canton, OH (US)

(21) Appl. No.: 16/892,783

(22) Filed: Jun. 4, 2020

(51) Int. Cl. F16D 65/14; B61H 15/00; B61H 1/00; B61H 3/00; F16D 65/52; F16D 65/08

(52) U.S. Cl. CPC F16D 65/14; B61H 15/0007; F16D 65/08; B61H 3/00; F16D 65/52; B61H 1/003

(57) ABSTRACT

A braking system for a steel wheeled vehicle is provided. The braking system includes an actuator assembly and a brake member operably engaged with the actuator assembly. The brake member contacts a flat surface of a wheel of the steel wheeled vehicle. A method for applying brakes to a steel wheeled vehicle is also provided. The method includes applying brake pressure, via a brake member, to a flat surface of a wheel of the steel wheeled vehicle.

### TECHNICAL FIELD

The present disclosure relates generally to the field of braking. More particularly, the present disclosure relates to a system and method for applying brakes to a steel wheeled vehicle. Specifically, the present disclosure relates to a system and method applying brakes to a steel wheeled vehicle having improved performance.

### BACKGROUND

Steel wheeled vehicles come in many designs and configurations and are used for a multitude of purposes. One exemplary steel wheeled vehicle is a bogie, which is typically attached to a railway vehicle. The bogie, among other things, supports the railway vehicle, guides the railway vehicle, and improves ride performance of the railway vehicle.

A typical bogie includes a frame, one or more steel wheel sets, one or more axles, one or more suspension assemblies, a bolster, and a braking system. The braking system typically includes a brake shoe, actuators, and adjusters. Applying the brake causes the brake shoe to press against the tread of the wheels. This creates friction between the brake shoe and the tread of the wheels causing the bogie, and the railway vehicle, to slow down. The actuators and adjusters are typically positioned below the one or more axles and between the wheels.

However, there are some drawbacks associated with utilizing brake shoes that contact the tread of the wheels. One drawback includes the brake shoe wearing quickly and/or in an uneven manner due to the non-planar surface of the tread of the wheels. Another drawback includes causing wear to the tread of the wheels through direct contact between the brake shoe and the tread of the wheels. As the brake shoes and tread of the wheels become worn, they typically need to be replaced at a high cost.

Another drawback includes the positioning of the actuators and adjusters. Positioning the actuators and adjusters below the one or more axles and between the wheels causes the actuators and adjusters to be close to the railroad rails, the ground, and/or debris on the ground. If the actuators and adjusters come into contact with the railroad rails, the ground, and/or the debris on the ground, the actuators and adjusters are easily broken. Replacing the actuators and adjusters is typically an expensive endeavor.

### SUMMARY

The present disclosure addresses these and other issues by providing a system and method for applying brakes to a steel wheeled vehicle.

In one aspect, the present disclosure may provide a braking system for a steel wheeled vehicle including an actuator assembly and a brake member operably engaged with the actuator assembly. The brake member contacts a flat surface of a wheel of the steel wheeled vehicle. The braking system further includes a brake surface of the brake member. The brake surface contacts an interior surface of a wheel flange of the wheel. The braking system further includes an axle of the steel wheeled vehicle operably engaged with the wheel and a bottommost point of the axle defining a plane tangent to the bottommost point. The actuator assembly is positioned above the plane.

The braking system further includes a slack adjuster operably engaged with the brake member. The braking system further includes an exterior surface of the wheel. The exterior surface of the wheel is free of any physical contact with the braking system. The braking system further includes a brake surface of the brake member. The brake surface is substantially orthogonal to a direction of travel of the wheel. The braking system further includes a frame assembly of the steel wheeled vehicle, an end of the frame assembly, and an axle of the steel wheeled vehicle operably engaged with the wheel. The axle is positioned proximate the end of the frame assembly. The brake member contacts the flat surface of the wheel between the end of the frame assembly and the axle.

In one example, the brake member is a first brake member, the wheel is a first wheel, and the braking system further includes a second brake member operably engaged with the actuator assembly. The first brake member contacts the flat surface of the first wheel of the steel wheeled vehicle and the second brake member contacts a flat surface of a second wheel of the steel wheeled vehicle. In one example, the braking system is positioned below a top of the wheel. In one example, the steel wheeled vehicle is a bogie.

In another aspect, the present disclosure may provide a method for applying brakes to a steel wheeled vehicle. The method includes applying brake pressure, via a brake member, to a flat surface of a wheel of the steel wheeled vehicle. The method includes applying the brake pressure, via the brake member, to an interior surface of a wheel flange of the wheel. The method includes applying the brake pressure, via a flat surface of the brake member, to the flat surface of the wheel. The method includes positioning an actuator assembly above a plane that is tangent to a bottommost point of an axle of the steel wheeled vehicle.

The method includes positioning a slack adjuster above a plane that is tangent to a bottommost point of an axle of the steel wheeled vehicle. The method includes setting, via the slack adjuster, an optimal distance between a brake surface of the brake member and an interior surface of a wheel flange of the wheel. The method includes applying the brake pressure, via the brake member, to the flat surface of the wheel in a substantially orthogonal direction relative to a direction of travel of the steel wheeled vehicle. The method includes applying the brake pressure, via the brake member, to the flat surface of the wheel between an end of a frame assembly of the steel wheeled vehicle and an axle proximate the end of the frame assembly.

In one example, the brake member is a first brake member, the wheel is a first wheel, and the method further includes applying the brake pressure, via the first brake member, to the flat surface of the first wheel and applying the brake pressure, via a second brake member, to a flat surface of a second wheel of the steel wheeled vehicle. The method further includes positioning the brake member below a top of the wheel.

In another aspect, the present disclosure may provide a braking system for a steel wheeled vehicle. The braking system includes an actuator assembly and a brake member operably engaged with the actuator assembly. The brake member contacts a flat surface of a wheel of the steel wheeled vehicle. A method for applying brakes to a steel wheeled vehicle is also provided. The method includes applying brake pressure, via a brake member, to a flat surface of a wheel of the steel wheeled vehicle.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an isometric perspective view of a braking system in accordance with one aspect of the present disclosure;

FIG. 2 is a side elevation view of a railway vehicle including two bogies;

FIG. 3 is an enlarged fragmentary view of one of the bogies highlighted by the dashed box labeled SEE FIG. 3 of FIG. 2;

FIG. 4 is an end elevation view of the bogie of FIG. 3 taken along line 4-4 of FIG. 3;

FIG. 5 is an enlarged fragmentary top plan view of the braking system operationally engaged with the bogie of FIG. 4 taken along line 5-5 of FIG. 4;

FIG. 6A is an operational view of FIG. 5 illustrating operation of the braking system;

FIG. 6B is an operational view of FIG. 5 illustrating operation of the braking system; and

FIG. 7 is a flow chart depicting an exemplary method in accordance with one aspect of the present disclosure.

Similar numbers refer to similar parts throughout the drawings.

### DETAILED DESCRIPTION

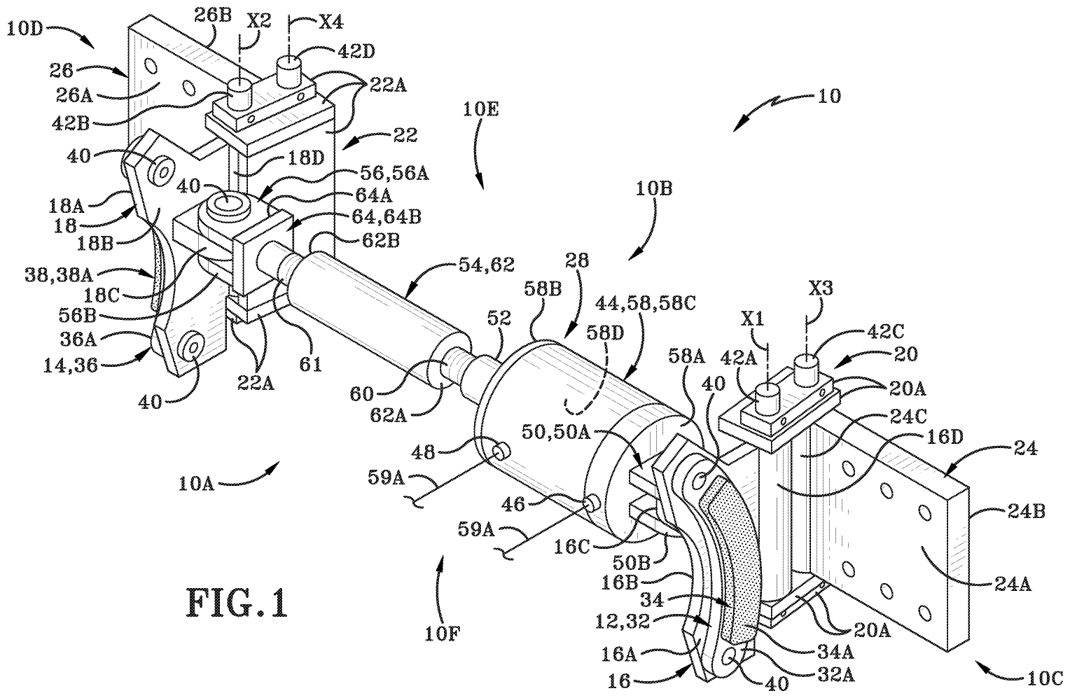

Referring to FIG. 1, there is shown a braking system for a steel wheeled vehicle in accordance with one aspect of the present disclosure generally indicated at 10. Braking system 10 includes a first brake member 12, a second brake member 14, a first mount 16, a second mount 18, a first pivot assembly 20, a second pivot assembly 22, a first bracket 24, a second bracket 26, and an actuator assembly 28.

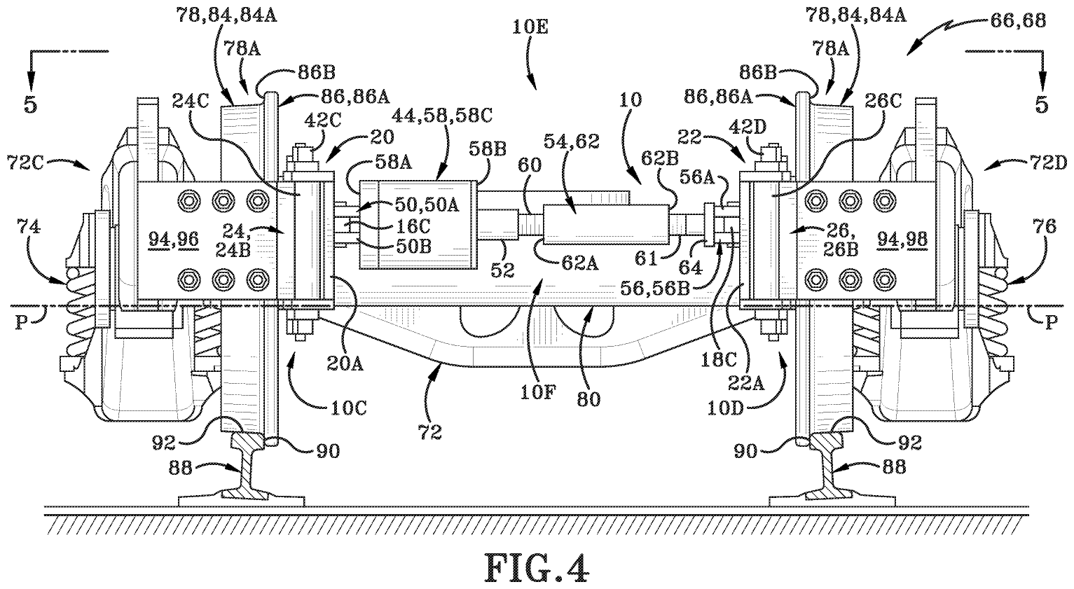

With reference to FIG. 1 and FIG. 4, the braking system 10 includes a first end 10A, a second end 10B, a first side 10C, a second side 10D, a top 10E (FIG. 4), and a bottom 10F (FIG. 4). The first end 10A and the second end 10B define a longitudinal direction therebetween. The first side 10C and the second side 10D define a transverse direction therebetween. The top 10E and the bottom 10F define a vertical direction therebetween.

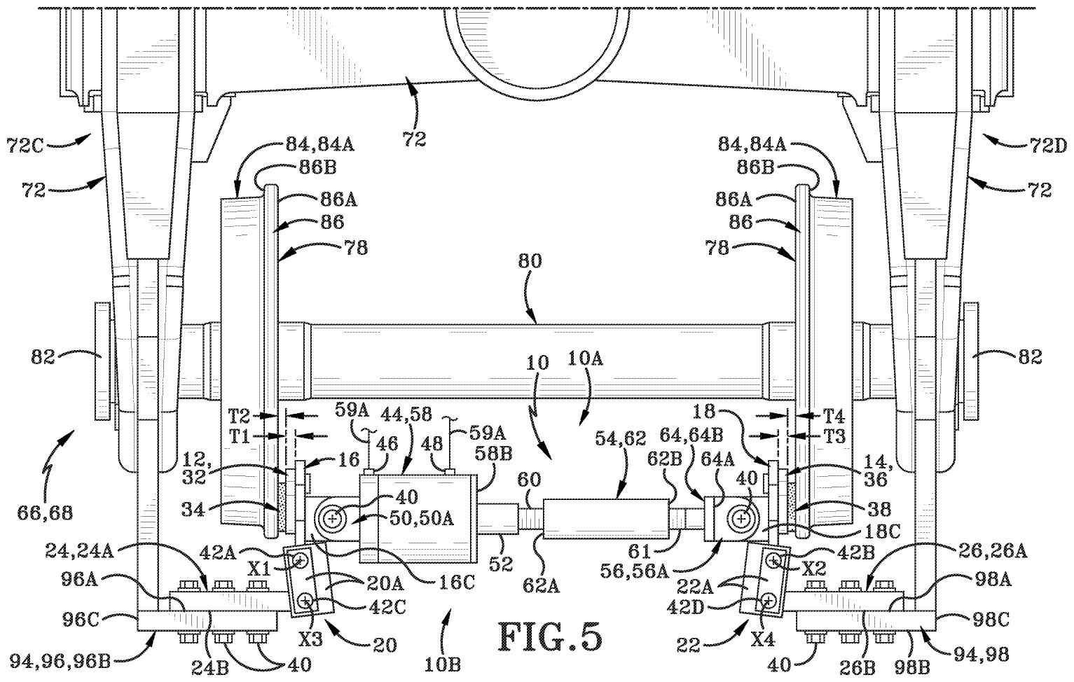

As shown in FIG. 1, the first brake member 12 includes a generally arcuate mount portion 32 and a generally arcuate friction portion 34. The mount portion 32 is configured to be complementary in shape to the friction portion 34. The mount portion 32 includes a rear surface (not shown) and a front surface 32A. The rear surface of the mount portion 32 and the front surface 32A define a thickness T1 (FIG. 5) extending therebetween. The friction portion 34 includes a rear surface (not shown) and a front surface 34A, which may also be referred to as brake surface 34A. In one example, the front surface 34A is a substantially flat surface. The rear surface of the friction portion 34 and the front surface 34A define a thickness T2 (FIG. 5) extending therebetween. The front surface 32A of the mount portion 32 is connected to the rear surface of the friction portion 34 via an adhesive. In one example, the thickness T1 is larger than the thickness T2, however, the thickness T1 and the thickness T2 can be any suitable thicknesses. Although the mount portion 32 and the friction portion 34 have been described as being generally arcuate in shape, it is to be understood that the mount portion 32 and the friction portion 34 can be any suitable shape.

As shown in FIG. 1 and FIG. 5, the second brake member 14 includes a generally arcuate mount portion 36 and a generally arcuate friction portion 38. The mount portion 36 is configured to be complementary in shape to the friction portion 38. The mount portion 36 includes a rear surface (not shown) and a front surface 36A. The rear surface of the mount portion 36 and the front surface 36A define a thickness T3 (FIG. 5) extending therebetween. The friction portion 38 includes a rear surface (not shown) and a front surface 38A, which may also be referred to as brake surface 38A. In one example, the front surface 38A is a substantially flat surface. The rear surface of the friction portion 38 and the front surface 38A define a thickness T4 (FIG. 5) extending therebetween. The front surface 36A of the mount portion 36 is connected to the rear surface of the friction portion 38 via an adhesive. In one example, the thickness T3 is larger than the thickness T4, however, the thickness T3 and the thickness T4 can be any suitable thicknesses. Although the mount portion 36 and the friction portion 38 have been described as being generally arcuate in shape, it is to be understood that the mount portion 36 and the friction portion 38 can be any suitable shape.

With reference to FIG. 1 and FIG. 5, the first mount 16 includes a generally planar outer surface 16A, a generally planar inner surface 16B, a connecting portion 16C (FIG. 5), a sleeve 16D, and apertures (not shown) extending therethrough. The connecting portion 16C is connected to, and extends from, the inner surface 16B in a transverse direction substantially orthogonal relative to the inner surface 16B. The connecting portion 16C includes an aperture (not shown) extending therethrough. The mount portion 32 is connected to the first mount 16 via fasteners 40, such as, for example, bolts and nuts, extending through the apertures of the mount portion 32 and the apertures of the first mount 16 such that the rear surface of the mount portion 32 contacts the outer surface 16A of the first mount 16. The sleeve 16D includes a vertically extending bore (not shown) that is substantially orthogonal to the outer surface 16A and the inner surface 16B of the first mount 16.

With reference to FIG. 1 and FIG. 5, the second mount 18 includes a generally planar outer surface 18A, a generally planar inner surface 18B, a connecting portion 18C, and a sleeve 18D. The connecting portion 18C is connected to, and extends from, the inner surface 18B in a transverse direction substantially orthogonal relative to the inner surface 18B. The connecting portion 18C includes an aperture (not shown) extending therethrough. The mount portion 36 is connected to the second mount 18 via fasteners 40, such as, for example, bolts and nuts, extending through the apertures of the mount portion 36 and the apertures of the second mount 18 such that the rear surface of the mount portion 36 contacts the outer surface 18A of the second mount 18. The sleeve 18D includes a vertically extending bore (not shown) that is substantially orthogonal to the outer surface 18A and the inner surface 18B of the second mount 18.

With reference to FIG. 1 and FIG. 5, the first pivot assembly 20 includes a plurality of plates 20A. In one example, the plurality of plates 20A includes two generally rectangular plates and one generally elongated U-shaped plate, however, it is to be understood that any suitable number of plates having any suitable shape may be utilized. The plates 20A include apertures (not shown) extending therethrough such that some of the apertures of the plates 20A are coaxial with the vertically extending bore of the sleeve 16D. The first mount 16 is operably engaged with the first pivot assembly 20 via a first pivot pin 42A and fasteners. More particularly, the first pivot pin 42A extends through the coaxially aligned apertures of the plates 20A and the bore of the sleeve 16D and is held in place via the fasteners. The first pivot pin 42A defines a first vertically extending pivot axis X1 (FIG. 5). The first mount 16 is pivotable about the first pivot axis X1 as more fully described below.

With continued reference to FIG. 1, the second pivot assembly 22 includes a plurality of plates 22A. In one example, the plurality of plates 22A includes two generally rectangular plates and one generally elongated U-shaped plate, however, it is to be understood that any suitable number of plates having any suitable shape may be utilized. The plates 22A include apertures (not shown) extending therethrough such that some of the apertures of the plates 22A are coaxial with the vertically extending bore of the sleeve 18D. The second mount 18 is operably engaged with the second pivot assembly 22 via a second pivot pin 42B and fasteners. More particularly, the second pivot pin 42B extends through the coaxially aligned apertures of the plates 22A and the bore of the sleeve 18D and is held in place via the fasteners. The second pivot pin 42B defines a second vertically extending pivot axis X2 (FIG. 5). The second mount 18 is pivotable about the second pivot axis X2 as more fully described below.

With reference to FIG. 1 and FIG. 5, the first bracket 24 includes a front surface 24A, a rear surface 24B, a sleeve 24C, and a plurality of apertures (not shown) extending therethrough. The sleeve 24C includes a vertically extending bore (not shown) that is substantially orthogonal to the front surface 24A and the rear surface 24B. The first bracket 24 is operably engaged with the first pivot assembly 20 via a third pivot pin 42C and fasteners. Some of the apertures of the plates 20A are coaxial with the vertically extending bore of the sleeve 18D. More particularly, the third pivot pin 42C extends through the coaxially aligned apertures of the plates 20A and the bore of the sleeve 24C and is held in place via the fasteners. The third pivot pin 42C defines a third vertically extending pivot axis X3. The first pivot assembly 20 is pivotable about the third pivot axis X3 as more fully described below.

With reference to FIG. 1, FIG. 4, and FIG. 5, the second bracket 26 includes a front surface 26A, a rear surface 26B, a sleeve 26C (FIG. 4), and a plurality of apertures (not shown) extending therethrough. The sleeve 26C includes a vertically extending bore (not shown) that is substantially orthogonal to the front surface 26A and the rear surface 26B. The first bracket 26 is operably engaged with the second pivot assembly 22 via a fourth pivot pin 42D and fasteners. Some of the apertures of the plates 22A are coaxial with the vertically extending bore of the sleeve 26C. More particularly, the fourth pivot pin 42D extends through the coaxially aligned apertures of the plates 22A and the bore of the sleeve 26C and is held in place via the fasteners. The fourth pivot pin 42D defines a fourth vertically extending pivot axis X4 (FIG. 5). The second pivot assembly 22 is pivotable about the fourth pivot axis X4 as more fully described below.

With reference to FIG. 1 and FIG. 5, the actuator assembly 28 includes a hydraulic cylinder 44, a first port 46, a second port 48, a first link member 50, a piston rod 52, a slack adjuster 54, and a second link member 56.

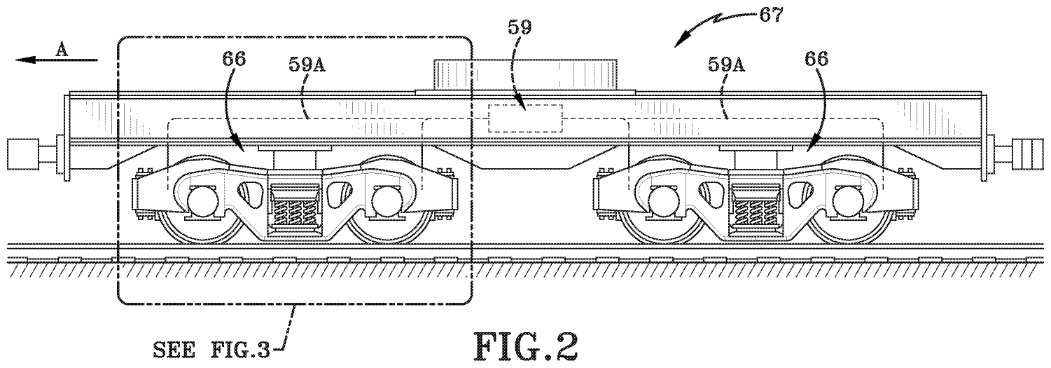

With reference to FIG. 1, FIG. 2, and FIG. 5, the hydraulic cylinder 44 includes a cylinder barrel 58 having a first end 58A, a second end 58B, a cylindrical portion 58C, and an interior chamber 58D. The first end 58A generally faces the inner surface 16A of the first mount 16. The second end 58B generally faces the inner surface 18A of the second mount 18. The first port 46 and the second port 48 are provided on the cylindrical portion 58C of the cylinder barrel 58 and are connected to a hydraulic assembly 59 (FIG. 2) via hydraulic fluid lines 59A. The first port 46 and the second port 48 allow fluid communication between the hydraulic lines 59A and the interior chamber 58D of the cylinder barrel 58.

With reference to FIG. 1 and FIG. 5, the first link member 50 includes a first link 50A and a second link 50B. The first link 50A and the second link 50B are connected to, and extend from, the first end 58A of the cylinder barrel 58 in a transverse direction substantially orthogonal relative to the first end 58A. The first link 50A is spaced a distance from the second link 50B. The first link 50A and the second link 50B include apertures (not shown) extending therethrough. The first link 50A and the second link 50B are connected to the connecting portion 16C of the first mount 16 via the fastener 40.

The piston rod 52 is operably engaged with a piston (not shown) within the interior chamber 58D of the cylinder barrel 58. The piston rod 52 is moveable in a transverse direction as more fully described below.

The slack adjuster 54 includes a first threaded rod 60, a second threaded rod 61, and an adjustment mechanism 62. The direction of the thread of the first threaded rod 60 is opposite to the direction of the thread of the second threaded rod 61. The adjustment mechanism 62 is generally cylindrical in shape and includes a first end 62A and a second end 62B. The adjustment mechanism 62 further includes a threaded bore (not shown) extending transversely through the first end 62A and the second end 62B along a length of the adjustment mechanism 62. The direction of the thread of the threaded bore proximate the first end 62A of the adjustment mechanism 62 is configured to threadingly receive first rod 60. The direction of the thread of the threaded bore proximate the second end 62B of the adjustment mechanism 62 is configured to threadingly receive second rod 60. The first rod 60 is fixedly connected to the piston rod 52 and the second rod 61 is fixedly connected to the second link member 56 as more fully described below. The first rod 60, the second rod 61, and the adjustment mechanism 62 are operable to move in transverse directions as more fully described below.

The second link member 56 includes first link 56A, a second link 56B, and a base 64. The base 64 is a generally rectangular member including an outer surface 64A and an inner surface 64B. The outer surface 64A and the inner surface 64B are generally parallel to the inner surface 18B of the second mount 18. The first link 56A and the second link 56B are connected to, and extend from, the outer surface 64A of the base 64 in a transverse direction substantially orthogonal relative to the outer surface 64A. The first link 56A is spaced a distance from the second link 56B. The first link 56A and the second link 56B include apertures (not shown) extending therethrough. The first link 56A and the second link 56B are connected to the connecting portion 18C of the second mount 18 via the fastener 40.

As stated above, the braking system 10 of the present disclosure is utilized with a steel wheeled vehicle. For exemplary purposes, and with primary reference to FIG. 2 through FIG. 4, the steel wheeled vehicle is depicted as a bogie 66, which is a chassis or framework carrying wheels. The bogie 66 is typically operably engaged with a railway vehicle 68. Although FIG. 2 depicts two bogies 66 operably engaged with the railway vehicle 68, both bogies 66 are substantially identical and, therefore, only one bogie 66 will be further described herein. Although the braking system 10 will be described herein with reference to the bogie 66, it is to be understood that the braking system 10 can be utilized with any suitable steel wheeled vehicle.

With to FIG. 2 through FIG. 4, the bogie 66 includes a first wheel assembly 68, a second wheel assembly 70, a frame assembly 72, a first suspension assembly 74 and a second suspension assembly 76. The first wheel assembly and the second wheel assembly 70 are substantially identical, and, therefore, only the first wheel assembly will be described herein.

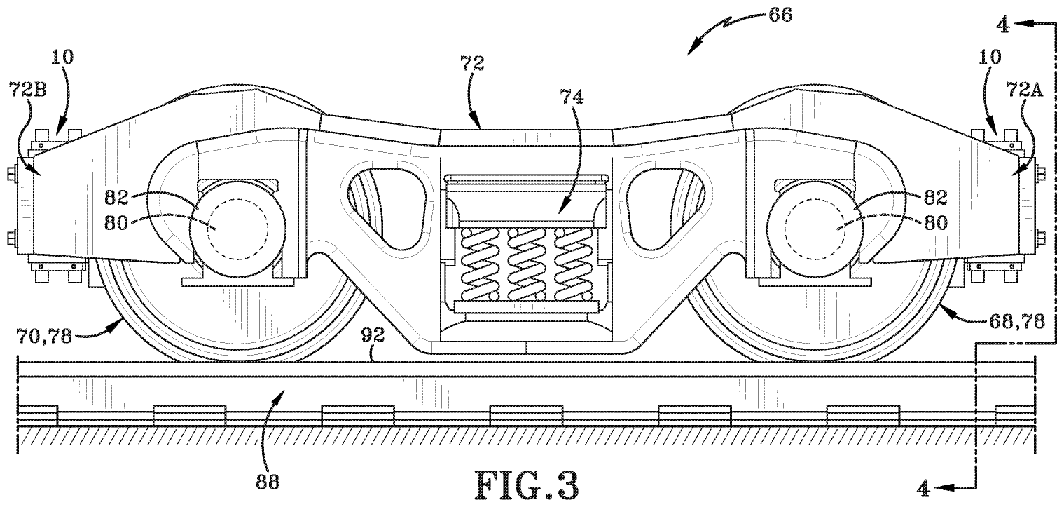

With reference to FIG. 3 and FIG. 4, the first wheel assembly 68 includes two wheels 78, an axle 80, and bearings 82. The wheels 78 each include a top 78A, a semi-conical portion 84 and a wheel flange 86. The semi-conical portion 84 includes a tread 84A and the wheel flange 86 includes an interior surface 86A and an exterior surface 86B. In one example, the interior surface 86A of the wheel flange is a generally flat surface. The tread 84A and the exterior surface 86B are adapted to operably engage with rails 88, such as, for example, an inner edge 90 and a top surface 92 of the rails 88. More particularly, the tread 84 is adapted to operably engage with the top surface 92 of the rails 88 and the exterior surface 86B of the wheel flange 86 is adapted to operably engage the inner edge 90 of the rails 88. The wheels 78 are fixedly attached to the axle 80 and, therefore, rotate in unison with the axle 80 about the bearings 82. The axle 80 defines a horizontal plane P (FIG. 4) tangent to a bottommost point on the axle 80.

With continued reference to FIG. 2 through FIG. 5, the frame assembly 72 includes a first end 72A, a second end 72B, a first side 72C, and a second side 72D. The frame assembly 72 further includes a plurality of frame brackets 94. In one example, the frame assembly 72 includes two frame brackets 94 provided proximate the first end 72A and two frame brackets proximate the second end 72B. As the frame brackets 94 are substantially identical, only two frame brackets 94 proximate the first end 72A will be discussed herein and will be referred to as first frame bracket 96 and second frame bracket 98.

With primary reference to FIG. 5, the first frame bracket 96 includes an inner surface 96A, an outer surface 96B, a frame end portion 96C, and a plurality of apertures (not shown) extending therethrough. The first frame bracket 96 is connected to the first side 72C of the frame assembly 72 and extends in a transverse direction such that the inner surface 96A and the outer surface 96B are substantially orthogonal to the first side 72C of the frame assembly 72. More particularly, the frame end portion 96C is connected to the first side 72C of the frame assembly 72 via a bond, such as, for example, a weld; however, the frame end portion 96C may be connected to the first side 72C of the frame assembly 72 in any suitable manner. The apertures of the first bracket 24 are coaxial to the apertures of the first frame bracket 96. The first bracket 24 is connected to the first frame bracket 96 via the fasteners 40, such as, for example, bolts and nuts; however, the first bracket 24 may be connected to the first frame bracket 96 in any suitable manner, including, but not limited to, being integrally formed with one another.

With primary reference to FIG. 5, the second frame bracket 98 includes an inner surface 98A, an outer surface 98B, a frame end portion 98C, and a plurality of apertures (not shown) extending therethrough. The second frame bracket 98 is connected to the second side 72D of the frame assembly 72 and extends in a transverse direction such that the front surface 98A and the rear surface 98B are substantially orthogonal to the second side 72D of the frame assembly 72. More particularly, the frame end portion 98C is connected to the second side 72D of the frame assembly 72 via a bond, such as, for example, a weld; however, the frame end portion 98C may be connected to the second side 72C of the frame assembly 72 in any suitable manner. The apertures of the second bracket 26 are coaxial to the apertures of the second frame bracket 98. The second bracket 26 is connected to the second frame bracket 98 via the fasteners 40, such as, for example, bolts; however, the second bracket 26 may be connected to the second frame bracket 98 in any suitable manner, including, but not limited to, being integrally formed with one another.

With primary reference to FIG. 2 through FIG. 5, the braking system 10 is positioned such that the front surface 34A of the friction portion 34 is positioned proximate the interior surface 86A of the wheel flange 86 of one of the wheels 78. The front surface 34A faces a direction that is orthogonal to a direction of travel of the wheels 78, which is indicated by arrow A (FIG. 2). Likewise, the front surface 38A of the friction portion 38 is positioned proximate the interior surface 86A of the wheel flange 86 of the other wheel 78. The front surface 38A faces a direction that is orthogonal to the direction of travel of the wheels 78 indicated by arrow A (FIG. 2). Further, the components of the actuator assembly 28 (i.e., the hydraulic cylinder 44, the first port 46, the second port 48, the first link member 50, the piston rod 52, the slack adjuster 54, the second link member 56, and their associated components) are all positioned above the plane P. In one example, the braking system 10, and its associated components, are positioned below the top 78A of the wheels 78 and between the axle 80 and the first end 72A of the frame assembly 72. In another example, the first brake member 12 and the second brake member 14 contact, via the friction portion 34 and the friction portion 38, the interior surface 86A of the flange of the wheels 78 between the axle 80 and the first end 72A of the frame assembly 72.

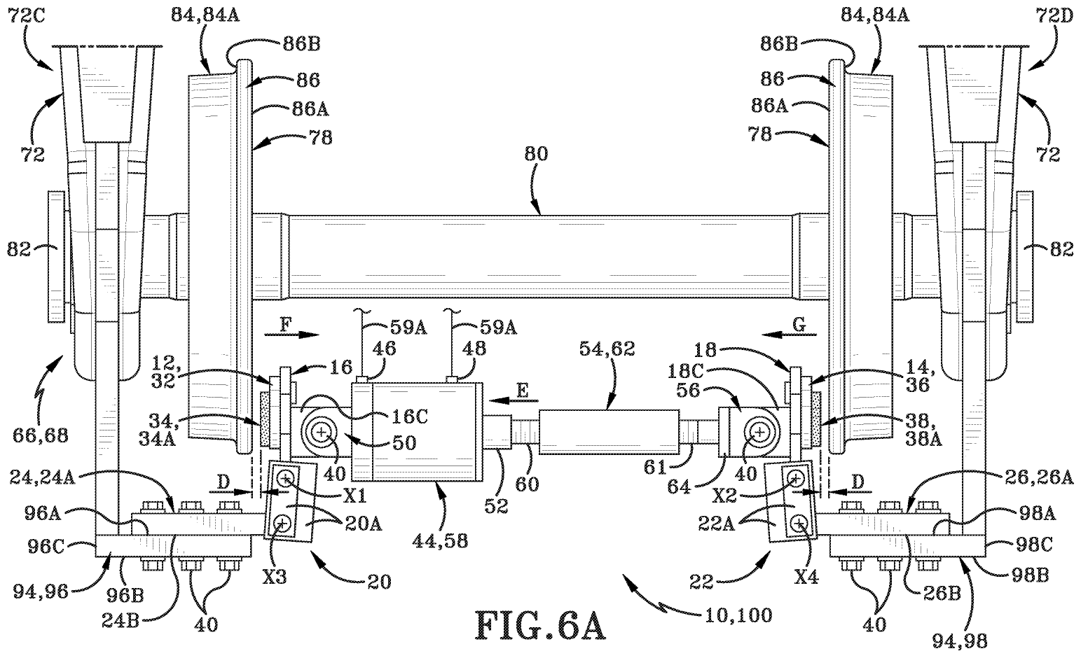

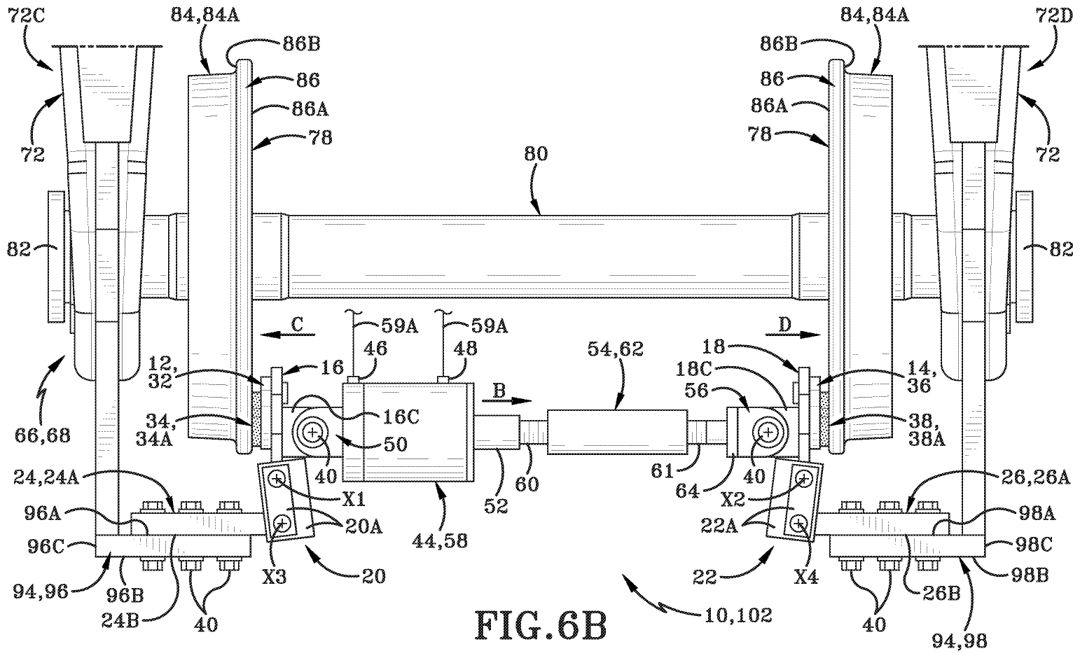

Having thus described the structure of the braking system 10, and its associated components, primary reference is now made to FIG. 6A and FIG. 6B to depict one exemplary use and operation of the braking system 10 with a steel wheeled vehicle. Although the bogie 66 includes two braking systems 10, only one braking system 10 will be described herein for exemplary purposes.

With primary reference to FIG. 6A, an operator (not shown) sets an optimal distance D, which may also be referred to as optimal clearance, between the front surface 34A of the friction portion 34 and the interior surface 86A of the wheel flange 86 of one wheel 78 and between the front surface 38A of the friction portion 38 and the interior surface 86A of the wheel flange 86 of the other wheel 78. When the friction portion 34 and the friction portion 38 wear and/or when the interior surface 86A of the wheel flange 86 wears, the optimal distance D is affected (i.e., the distance between the front surface 34A of the friction portion 34 and the interior surface 86A of the wheel flange 86 of one wheel 78 and the distance between the front surface 38A of the friction portion 38 and the interior surface 86A of the wheel flange 86 of the other wheel 78 is greater than the optimal distance D). As such, the distance between the front surface 34A of the friction portion 34 and the interior surface 86A of the wheel flange 86 of one wheel 78 and the distance between the front surface 38A of the friction portion 38 and the interior surface 86A of the wheel flange 86 of the other wheel 78 need to be adjusted to the optimal distance D.

This is accomplished via the slack adjuster 54 by manipulating the adjustment mechanism 62 to set the distance between the front surface 34A of the friction portion 34 and the interior surface 86A of the wheel flange 86 of one wheel 78 and the distance between the front surface 38A of the friction portion 38 and the interior surface 86A of the wheel flange 86 of the other wheel 78 to the optimal distances D. More particularly, the adjustment mechanism 62 is rotatable in a first direction and a second direction. When the adjustment mechanism 62 rotates in the first direction, the first rod 60 extends away from the adjustment mechanism 62 in a transverse direction and the second rod 61 extends away from the adjustment mechanism 62 in a transverse direction opposite to the transverse direction of the first rod 60. As such, rotating the adjustment mechanism 62 in the first direction decreases the distance between the front surface 34A of the friction portion 34 and the interior surface 86A of the wheel flange 86 of one wheel 78 and the distance between the front surface 38A of the friction portion 38 and the interior surface 86A of the wheel flange 86 of the other wheel 78 to the optimal distances D.

When the adjustment mechanism 62 rotates in the second direction, the first rod 60 retracts into the adjustment mechanism 62 in a transverse direction and the second rod 61 retracts into the adjustment mechanism 62 in a transverse direction opposite to the transverse direction of the first rod 60. As such, rotating the adjustment mechanism 62 in the second direction increases the distance between the front surface 34A of the friction portion 34 and the interior surface 86A of the wheel flange 86 of one wheel 78 and the distance between the front surface 38A of the friction portion 38 and the interior surface 86A of the wheel flange 86 of the other wheel 78 to the optimal distances D or to aid in replacing worn components, such as, for example, the friction portion 34 and the friction portion 38.

In one example, the optimal distance D is approximately one millimeter, however, the optimal distance D may be any suitable distance. Further, although a manual slack adjuster 54 has been described relative to the braking system 10, it is to be understood that the slack adjuster 54 can also be configured to automatically adjust distances to the optimal distance D or to aid in replacing worn components.

With primary reference to FIG. 6A and FIG. 6B, the braking system 10 is moveable between a non-braking position 100, which may also be referred to as a first position, and a braking position 102, which may also be referred to as a second position. More particularly, FIG. 6A depicts the braking system 10 in the non-braking position 100. When the operator engages the braking system 10, the piston rod 52 moves in a transverse direction indicated by arrow B which causes the first brake member 12 to move in a transverse direction indicated by arrow C, and the second brake member 14 to move in a transverse direction indicated by arrow D. When the operator disengages the braking system 10, the piston rod 52 moves in a transverse direction indicated by arrow E which causes the first brake member 12 to move in a transverse direction indicated by arrow F, and the second brake member 14 to move in a transverse direction indicated by arrow G.

More particularly, when the operator engages the braking system 10, hydraulic fluid (not shown) enters the first port 46 causing the piston rod 52 to move in the direction indicated by arrow B. This causes the first mount 16 to pivot about the first pivot axis X1, the first pivot assembly 20 to pivot about the third pivot axis X3, and the front surface 34A of the friction portion 34 to move in the direction indicated by arrow C. The front surface 34A of the friction portion 34 contacts the interior surface 86A of the wheel flange 86 of one of the wheels 78. This also causes the second mount 18 to pivot about the second pivot axis X2, the second pivot assembly 22 to pivot about the fourth pivot axis X4, and the front surface 38A of the friction portion 38 to move in the direction indicated by arrow D. The front surface 38A of the friction portion 38 contacts the interior surface 86A of the wheel flange 86 of the other wheel 78. As such, the braking pressure applied to the interior surface 86A of the wheel flange 86 of both wheels 78 causes the bogie 66 to slow down and/or come to a complete stop.

When the operator disengages the braking system 10, hydraulic fluid enters the second port 48 causing the piston rod 52 to move in the direction indicated by arrow E. This causes the first mount 16 to pivot about the first pivot axis X1, the first pivot assembly 20 to pivot about the third pivot axis X3, and the front surface 34A of the friction portion 34 to move in the direction indicated by arrow F. The front surface 34A of the friction portion 34 releases contact with the interior surface 86A of the wheel flange 86 of one of the wheels 78. This also causes the second mount 18 to pivot about the second pivot axis X2, the second pivot assembly 22 to pivot about the fourth pivot axis X4, and the front surface 38A of the friction portion 38 to move in the direction indicated by arrow G. The front surface 38A of the friction portion 38 releases contact with the interior surface 86A of the wheel flange 86 of the other wheel 78. As such, the braking pressure applied to the interior surface 86A of the wheel flange 86 of both wheels 78 is removed and the bogie 66 is free to move as desired.

It should be noted that some of the benefits of the braking system 10 for steel wheeled vehicles of the present disclosure compared to conventional braking systems for steel wheeled vehicles are at least that: a) the braking system 10 applies braking pressure to a flat surface of the wheels 78 (i.e., the front surface 34A of the friction portion 34 and the front surface 38A of the friction portion 38 make contact with the interior surface 86A of the wheel flange 86 of the wheels 78) reducing wear of the braking system 10 components and the wheels 78; b) the braking system 10 applies pressure in a direction orthogonal to the direction of travel allowing easier replacement of the braking system 10 components and reducing wear of the braking system 10 components and wheels 78; c) the components of the actuator assembly 28 (i.e., the hydraulic cylinder 44, the first port 46, the second port 48, the first link member 50, the piston rod 52, the slack adjuster 54, and the second link member 56) are all positioned above the plane P reducing the likelihood of the braking system 10 components being broken; and d) the exterior surface 86B of the wheel flange 86 of the wheels 78 and the semi-conical portion 84 of the wheels 78 are free of any physical connections to the braking system 10, reducing the number of components of the braking system 10 and allowing easier replacement of braking system 10 components.

Although particular types of connections between various components of the braking system 10 and the steel wheeled vehicle (i.e., the bogie 66) have been described, such as for example, a bonded connection between the mount portion 32 and the friction portion 34, a bonded connection between the mount portion 36 and the friction portion 38, a mechanical connection between the mount portion 32 and the outer surface 16A, and a mechanical connection between the mount portion 36 and the outer surface 18A, it is to be understood that the connections between the various components of the braking system 10 and between the braking system 10 components and the bogie 66 can be any suitable types of connections.

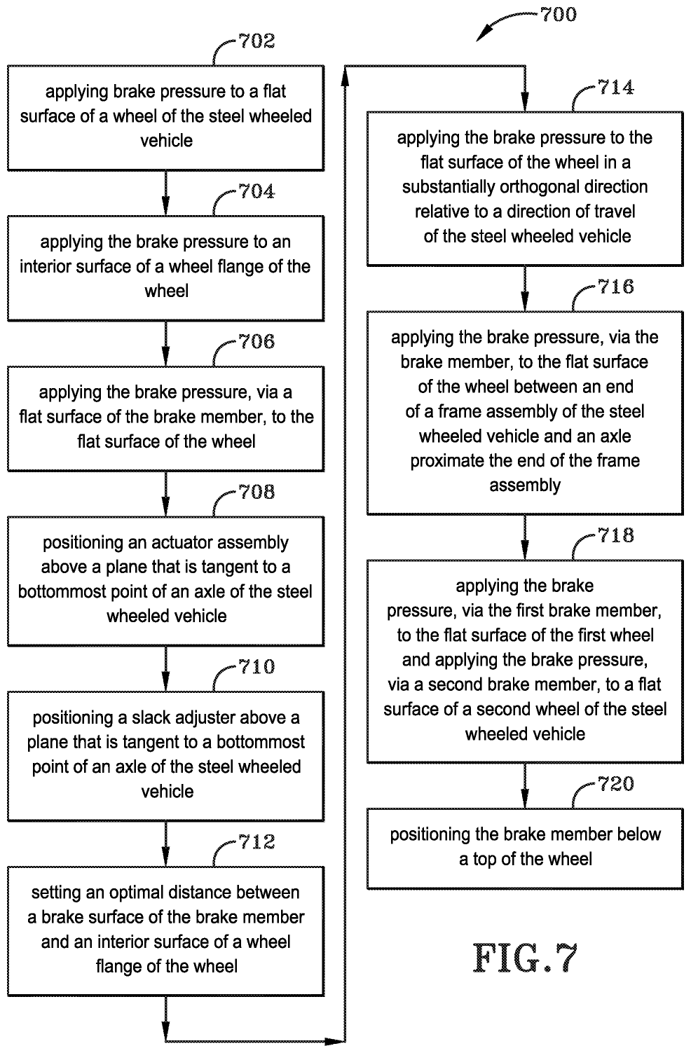

FIG. 7 depicts a method for applying brakes to a steel wheeled vehicle generally at 700. The method 700 includes applying brake pressure, via a brake member, to a flat surface of a wheel of the steel wheeled vehicle, which is shown generally at 702. The method 700 includes applying the brake pressure, via the brake member, to an interior surface of a wheel flange of the wheel, which is shown generally at 704. The method 700 includes applying the brake pressure, via a flat surface of the brake member, to the flat surface of the wheel, which is shown generally at 706. The method 700 includes positioning an actuator assembly above a plane that is tangent to a bottommost point of an axle of the steel wheeled vehicle, which is shown generally at 708. The method 700 includes positioning a slack adjuster above a plane that is tangent to a bottommost point of an axle of the steel wheeled vehicle, which is shown generally at 710. The method 700 includes setting, via the slack adjuster, an optimal distance between a brake surface of the brake member and an interior surface of a wheel flange of the wheel, which is shown generally at 712. The method 700 includes applying the brake pressure, via the brake member, to the flat surface of the wheel in a substantially orthogonal direction relative to a direction of travel of the steel wheeled vehicle, which is shown generally at 714. The method 700 includes applying the brake pressure, via the brake member, to the flat surface of the wheel between an end of a frame assembly of the steel wheeled vehicle and an axle proximate the end of the frame assembly, which is shown generally at 716. In one example, the brake member is a first brake member, the wheel is a first wheel, and the method 700 further includes applying the brake pressure, via the first brake member, to the flat surface of the first wheel and applying the brake pressure, via a second brake member, to a flat surface of a second wheel of the steel wheeled vehicle, which is shown generally at 718. The method 700 further includes positioning the brake member below a top of the wheel, which is shown generally at 720.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A braking system for a steel wheeled vehicle, comprising:
an actuator assembly; and
a brake member operably engaged with the actuator assembly; wherein the brake member contacts a flat surface of a wheel of the steel wheeled vehicle.

2. The braking system of claim 1, further comprising:
a brake surface of the brake member; wherein the brake surface contacts an interior surface of a wheel flange of the wheel.

3. The braking system of claim 1, further comprising:
an axle of the steel wheeled vehicle operably engaged with the wheel; and
a bottommost point of the axle defining a plane tangent to the bottommost point;
wherein the actuator assembly is positioned above the plane.

4. The braking system of claim 1, further comprising:
a slack adjuster operably engaged with the brake member.

5. The braking system of claim 1, further comprising:
an exterior surface of the wheel; wherein the exterior surface of the wheel is free of any physical contact with the braking system.

6. The braking system of claim 1, further comprising:
a brake surface of the brake member; wherein the brake surface is substantially orthogonal to a direction of travel of the wheel.

7. The braking system of claim 1, further comprising:
a frame assembly of the steel wheeled vehicle;
an end of the frame assembly; and
an axle of the steel wheeled vehicle operably engaged with the wheel; wherein the axle is positioned proximate the end of the frame assembly; and wherein the brake member contacts the flat surface of the wheel between the end of the frame assembly and the axle.

8. The braking system of claim 1, wherein the brake member is a first brake member; wherein the wheel is a first wheel, the braking system further comprising:
a second brake member operably engaged with the actuator assembly; wherein the first brake member contacts the flat surface of the first wheel of the steel wheeled vehicle; and wherein the second brake member contacts a flat surface of a second wheel of the steel wheeled vehicle.

9. The braking system of claim 1, wherein the braking system is positioned below a top of the wheel.

10. The braking system of claim 1, wherein the steel wheeled vehicle is a bogie.

11. A method for applying brakes to a steel wheeled vehicle, comprising:
applying brake pressure, via a brake member, to a flat surface of a wheel of the steel wheeled vehicle.

12. The method of claim 11, further comprising:
applying the brake pressure, via the brake member, to an interior surface of a wheel flange of the wheel.

13. The method of claim 11, further comprising:
applying the brake pressure, via a flat surface of the brake member, to the flat surface of the wheel.

14. The method of claim 11, further comprising:
positioning an actuator assembly above a plane that is tangent to a bottommost point of an axle of the steel wheeled vehicle.

15. The method of claim 11, further comprising:
positioning a slack adjuster above a plane that is tangent to a bottommost point of an axle of the steel wheeled vehicle.

16. The method of claim 15, further comprising:
setting, via the slack adjuster, an optimal distance between a brake surface of the brake member and an interior surface of a wheel flange of the wheel.

17. The method of claim of claim 11, further comprising:
applying the brake pressure, via the brake member, to the flat surface of the wheel in a substantially orthogonal direction relative to a direction of travel of the steel wheeled vehicle.

18. The method of claim 11, further comprising:
applying the brake pressure, via the brake member, to the flat surface of the wheel between an end of a frame assembly of the steel wheeled vehicle and an axle proximate the end of the frame assembly.

19. The method of claim 11, wherein the brake member is a first brake member; wherein the wheel is a first wheel; the method further comprising:
applying the brake pressure, via the first brake member, to the flat surface of the first wheel; and
applying the brake pressure, via a second brake member, to a flat surface of a second wheel of the steel wheeled vehicle.

20. The method of claim 11, further comprising:
positioning the brake member below a top of the wheel.
